(19) United States
(12) Patent Application Publication
(10) Pub. No.: US 2013/0019235 A1
(43) Pub. Date: Jan. 17, 2013

(54) MECHANISM FOR FACILITATING MANAGEMENT OF METADATA AND METADA-BASED UPDATE OF SOFTWARE

(71) Applicant: STEVEN TAMM, San Francisco, CA (US)

(72) Inventor: STEVEN TAMM, San Francisco, CA (US)

(73) Assignee: Salesforce.com, inc., San Francisco, CA (US)

(21) Appl. No.: 13/281,174

(22) Filed: Oct. 25, 2011

Related U.S. Application Data
(60) Provisional application No. 61/506,427, filed on Jul. 11, 2011.

(51) Int. Cl. G06F 9/44

(52) U.S. Cl. 717/170

(57) ABSTRACT

In accordance with embodiments, there are provided mechanisms and methods for facilitating management of metadata in an on-demand services environment. In one embodiment and by way of example, a method for facilitating management of metadata in an on-demand services environment is provided. The method of embodiment includes receiving metadata relating to a software application. The metadata may be received from one or more users via one or more computing devices hosting the software application. The method of embodiment may further include generating a platform setup entity to process the received metadata, updating existing metadata of the software application using the received metadata, and packaging a newer version of the software application having the updated existing metadata.

### CLAIM OF PRIORITY

This application claims the benefit of U.S. Provisional Patent Application No. 61/506,427, entitled “Setup Business Platform Objects” by Steven Tamm, filed Jul. 11, 2011 (Attorney Docket No. 8956P057Z), the entire contents of which are incorporated herein by reference and priority is claimed thereof.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for facilitating management of metadata and metadata-based update of software applications in an on-demand services environment.

### BACKGROUND

As metadata relating to a software application gets created or changed, it becomes important that the software application is then updated in light of the newly created or changed metadata. However, conventional systems of metadata-based updating of software applications are associated with various limitations and thus can get fairly complex and cumbersome.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### SUMMARY

In accordance with embodiments, there are provided mechanisms and methods for facilitating management of metadata in an on-demand services environment. In one embodiment and by way of example, a method for facilitating management of metadata in an on-demand services environment is provided. The method of embodiment includes receiving metadata relating to a software application. The metadata may be received from one or more users via one or more computing devices hosting the software application. The method of embodiment may include generating a platform setup entity to process the received metadata, and updating existing metadata of the software application using the received metadata.

While the present invention is described with reference to an embodiment in which techniques for facilitating management of data in an on-demand services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing system employing metadata management mechanism according to one embodiment;

FIG. 2 illustrates metadata management mechanism employed at a computing device according to one embodiment;

FIG. 3 illustrates a network of computing devices using metadata management mechanism according to one embodiment;

FIG. 4 illustrates a method for facilitating management of metadata for updating software applications in an on-demand services environment according to one embodiment;

FIG. 5 illustrates a computer system according to one embodiment;

FIG. 6 illustrates a block diagram of an environment wherein an on-demand database service might be used according to one embodiment; and

FIG. 7 illustrates a block diagram of an embodiment of elements of environment of FIG. 6 and various possible interconnections between these elements according to one embodiment.

### DETAILED DESCRIPTION

Methods and systems are provided for facilitating management of metadata in an on-demand service environment. A method of embodiments includes receiving metadata relating to a software application. The metadata may be received from one or more users via one or more computing devices hosting the software application. The method of embodiment may further include generating a platform setup entity to process the received metadata, updating existing metadata of the software application using the received metadata, and packaging a newer version of the software application having the updated existing metadata.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for metadata-based updating of software applications in an on-demand service environment will be described with reference to example embodiments.

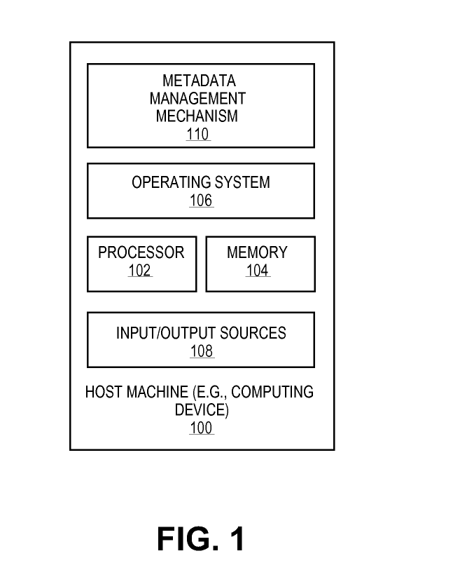

FIG. 1 illustrates a computing system employing metadata management mechanism according to one embodiment. In one embodiment, a computing device 100 serves as a host machine hosting software metadata management mechanism 110 to facilitate management of metadata relating to software applications, such as automatically updating software applications based on changing metadata in an on-demand services environment. Computing device 100 may include mobile computing devices, such as cellular phones including smartphones (e.g., iPhone®, BlackBerry®, etc.), handheld computing devices, personal digital assistants (PDAs), etc., tablet computers (e.g., iPad®, Samsung® Galaxy Tab®, etc.), laptop computers (e.g., notebooks, netbooks, etc.), e-readers (e.g., Kindle®, Nook®, etc.), etc. Computing device 100 may further include set-top boxes (e.g., Internet-based cable television set-top boxes, etc.), and larger computing devices, such as desktop computers, server computers, cluster-based computers, etc.

Computing device 100 includes an operating system 106 serving as an interface between any hardware or physical resources of the computer device 100 and a user. Computing device 100 further includes one or more processors 102, memory devices 104, network devices, drivers, or the like, as well as input/output sources 108, such as touchscreens, touch panels, touch pads, virtual or regular keyboards, virtual or regular mice, etc. It is to be noted that terms like “node”, “computing node”, “client”, “server”, “machine”, “device”, “computing device”, “computer”, “computing system”, “multi-tenant on-demand data system”, and the like, are used interchangeably and synonymously throughout this document.

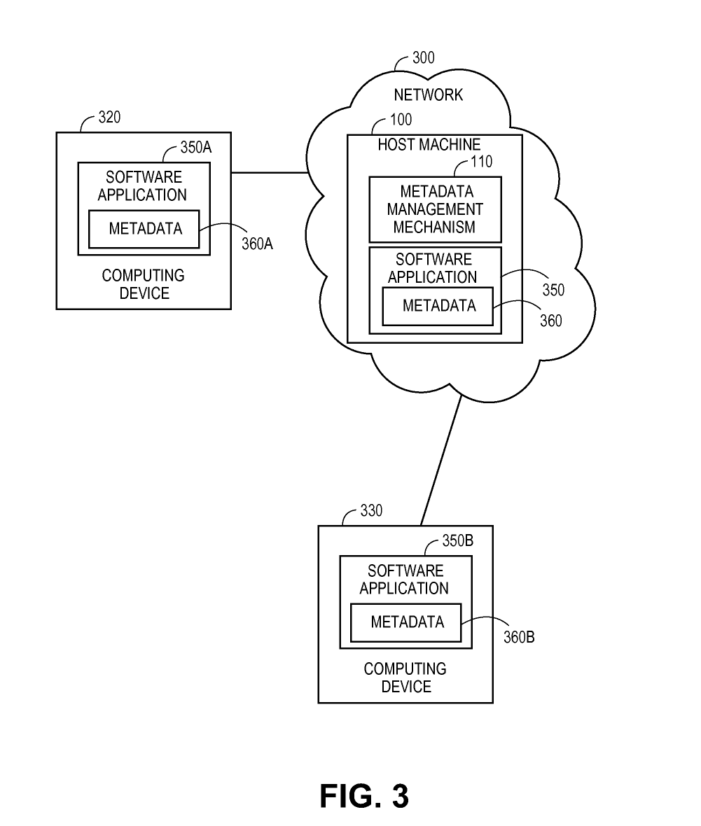

In one embodiment, new metadata be created or an update to existing metadata may be proposed by a user (e.g., end-user, customer, a tenant of the system, etc.) using an interface (e.g., a graphical user interface (GUI), etc.) at a client computing system. Such new metadata and or updates to existing metadata may be tracked, received and stored at a database to be later used to automatically update the relevant software applications using the software metadata management mechanism 110 at computing system 100. In one embodiment, computing system 100 may be in communication with multiple client computing systems over a network as will be further illustrated with reference to FIG. 3.

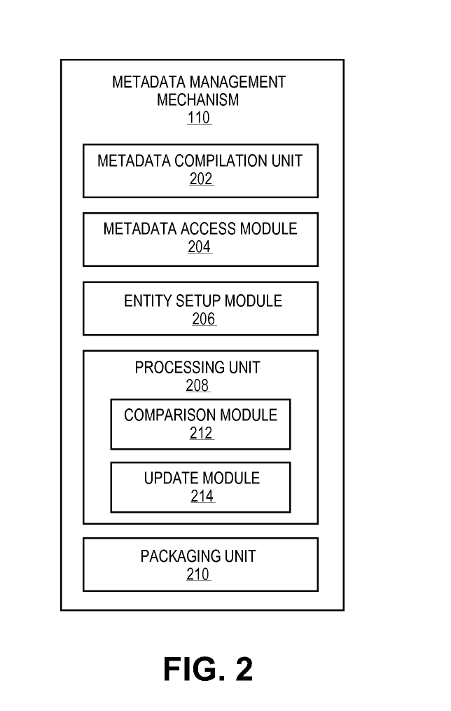

FIG. 2 illustrates metadata management mechanism employed at a computing device according to one embodiment. In one embodiment, metadata management mechanism 110 includes various components 202, 204, 206, 208, 210, 212, and 214 to offer a number of services to facilitate management of metadata and the metadata-based updating of software applications in an on-demand services environment. For example and in one embodiment, a user (e.g., an end-user at a client computing system) may propose a metadata update (e.g., new metadata, change to or deletion of existing metadata, etc.) to a software application being accessed by the user using the client computing system. The software application may include any type or number of software application or program, such as word-processing applications (e.g., Word® by Microsoft®, iWork® Pages® by Apple®, etc.), spreadsheet applications (e.g., Excel® by Microsoft, Numbers® by Apple, etc.), presentation applications (e.g., PowerPoint® by Microsoft, Keynote® by Apple, etc.), social media websites (e.g., Facebook®, LinkedIn®, etc.), collaboration applications (e.g., Chatter® by Salesforce®, SharePoint® by Microsoft, etc.), Web browsers (e.g., Chrome® by Google®, Explorer® by Microsoft, Safari® by Apple, etc.), and the like.

For example, Chatter may be the collaboration application of choice at various organizations (e.g., e.g., a company, a charitable organization, a government organization, an accounting firm, a legal firm, a hospital, a small business, etc.), but each organization and even each individual (e.g., an employee, a contractor, a volunteer, a visitor, etc.) at a single organization may have a different level of access to Chatter depending on a number of factors, such as the organization's size, goal, an individual's position (e.g., accountant, software developer, system administrator, attorney, central financial officer (CFO), etc.) with the organization, etc. In this case, certain metadata may be associated with Chatter corresponding to each user and/or organization depending on, for example, type or level of access and/or use by each individual and/or organization. Similarly, for example, Chrome may be the Web browser of choice at a company, but access to certain websites (e.g., illicit websites, political websites, sports websites, religious websites, etc.) may be limited to user based on their position with the company. In this case, different metadata may be associated with Chrome corresponding to each individual at the organization.

In one embodiment, a metadata compilation unit 202 of the metadata management mechanism 110 compiles, for example, the aforementioned-like metadata received from or communicated by various client computing devices as inserted or provided by customers (e.g., users, organization, etc.) according to their needs, goals, desires, etc. The compiled metadata may represent the new metadata, amended metadata, information regarding deleted metadata relating to any number or type of software applications and this complied metadata may be stored at a database to be accessed by the metadata management mechanism 110. The database may be part of the host machine 100 of FIG. 1 or remotely located at another (third-party) computing system that is accessible to the metadata management mechanism 110 over a network and via a metadata access module 204.

The metadata access module 204 may provide the ability to access the complied metadata at the database to that any relevant software applications may be updated using the metadata management mechanism 110 without having the need for a replication, a cross-object table (e.g., CrossOrgSites, AllOrganization, etc.), a global index, a special uniqueness, function-based indices, indices across multiple columns, fileforce, blobs, or the like. Further, this metadata-based updating of software applications, using the metadata management mechanism 110, eliminates the need to require a schema each time an update is needed and thus reduces or eliminates the need for schema-related downtime by using, for example and in one embodiment, the data manipulation language (DML) instead of the data definition language (DDL) for setup objects, and further reduces turnaround time for creating a setup object and provides a consistent way of developing metadata by facilitating automatic generation of metadata application programming interface (API), caching layer, packaging details, etc.

Further, in this way, standard objects of metadata (compiled and stored at the database) that support standardized platform behaviors may be created in a simplified and efficient manner. For example, software developers do not need to (re)write the entire code of a software application by simply using the techniques provided by the metadata management mechanism 110 as is further shown with reference to FIG. 3. For example and in one embodiment, using the metadata management mechanism 110, there may not remain any need to use the need to (re)code software applications using various programming languages, such as imperative or stored procedure languages to achieve basic functionalities, such as loading into and saving from EntityObjects, having custom fields, standardized sharing checks, etc. Examples of stored procedure or procedural languages include C++, Java®, Visual Basic, Procedural Language (PL)/Structured Query Language (SQL), or the like. Several platform behaviors, such as workflow, standard summary fields, apex triggers, API and Salesforce Object Query Language (SOQL) exposure, visual force support, etc., may involve, for example, none or minimal code (e.g., Java code, etc.). In one embodiment, metadata objects may be complied and stored at the database, such as stored within a single database table that can store all or any number of metadata objects. Further, creating a metadata object may include generating a subclass of the metadata object; for example, a concrete subclass may be created for the metadata object that may help handle one or more of the loading of the metadata object, the saving of the object, etc., or the metadata object may include a plurality of fields, such as a pool of standard fields may be implemented for the metadata object. One or more of the plurality of fields may be initialized (e.g., given a value, activated, deactivated, etc.) utilizing the compiled and stored metadata.

Referring back to the metadata access module 204, it access the metadata compiled and stored at the database for updating the current version (e.g., v.2) of the software application so that it may be updated to a newer version (e.g., v.3) using the most recently compiled metadata at the database. In one embodiment, an entity setup module 206 is used to generate a platform setup entity to facilitate the aforementioned updating of the software application. In one embodiment, the platform metadata setup entity (also referred to as “platform metadata entity”, “metadata entity” or “platform entity” or “setup entity”) may refer to a template or a structure to automatically and dynamically inherit the compiled metadata from the database in any sequence or quantity as necessary, desired or predetermined. In another embodiment, the platform metadata entity may be manually populated with the compiled metadata by a system administrator, a software developer, or the like.

For example, and in one embodiment, a platform metadata entity may be generated using an extensible markup language (XML) file (e.g., udd.xml, etc.) in combination with a number and type of parameters that may specify and/or define one or more fields, such as a primary key, a RecordTypeId, a CurrentIsoCode, audit fields, flex fields (e.g., flex fields of data type, such as text, email, phone, fax, currency, percent, dateonly, datetime, entityid, etc.). In one embodiment, a platform metadata entity may be dynamically and automatically created as facilitated by the entity setup module 206 as predefined based on, for example, a setup base platform object (BPO) framework and is put in communication with the compiled metadata at the database.

Once the metadata is fed into the platform metadata entity, the process is trigged using the processing unit 208 of the metadata management mechanism 110. The comparison module 212 of the processing unit 208 facilitates comparison or matching of the new metadata at the platform metadata entity with the already existing metadata of a software application. If the new metadata differs from the already existing metadata, appropriate changes or updates are made to the software application using an update module 214 of the processing unit 208. For example, using the update module 214, (1) if one or more new metadata items do not exist in the software application, the new metadata items are added to the software application, (2) if one or more new metadata items represents an update of or change to one or more corresponding existing metadata items of the software application, the one or more corresponding existing metadata items are updated accordingly or simply replaced by the new one or more metadata items, and (3) if one or more metadata items are indicated as being removed in the new metadata, then the corresponding one or more metadata items are removed from the software application. Once the software application metadata is updated, using a packaging unit 210, the software application is appropriately packaged (e.g., such as packaged into a software package) and the updated version is then sent to existing and potential customers. It is contemplated the new software package may be delivered to the customers using any number of techniques, such as through an Internet-based update to the customers' existing software or by providing a Compact-Disk (CD) having the updated software package, or the like.

It is contemplated that any number and type of components may be added to and removed from metadata management mechanism 110 to facilitate its workings and operability in facilitating automatic and dynamic update of metadata of software applications. For brevity, clarity, ease of understanding and to focus on the metadata management mechanism 110, many of the conventional or known components of a computing device are not shown or discussed here.

FIG. 3 illustrates a network of computing devices using metadata management mechanism according to one embodiment. In one embodiment, host machine (e.g., computing device) 100 employs metadata management mechanism 110 and is shown to be in communication with various client computing devices 320, 330 over a network 300 (e.g., cloud computing, Internet, intranet, Local Area Network (LAN), Wireless LAN (WLAN), Wide Area Network (WAN), Metropolitan Area Network (MAN), Personal Area Network (PAN), etc.). As illustrated, each of the computing devices 320, 330 may be running a software application 350A, 350B, while two users accessing their respective computing devices 320, 330 may be providing new metadata 360A, 360B (e.g., new metadata, updating or deleting existing metadata, etc.) associated with the software application 350A, 350B.

In one embodiment, as described with reference to FIG. 2, the metadata 360A, 360B is received, compiled and stored at a database via the metadata management mechanism 110. The compiled and stored metadata based on the metadata 360A, 360B provided by the user through computing devices 320, 330 is then used by the metadata management mechanism 110 to update metadata 360 of software application 350. The updated version of the software application 350 is then provided back to the users at computing devices 320, 330 via the network 300.

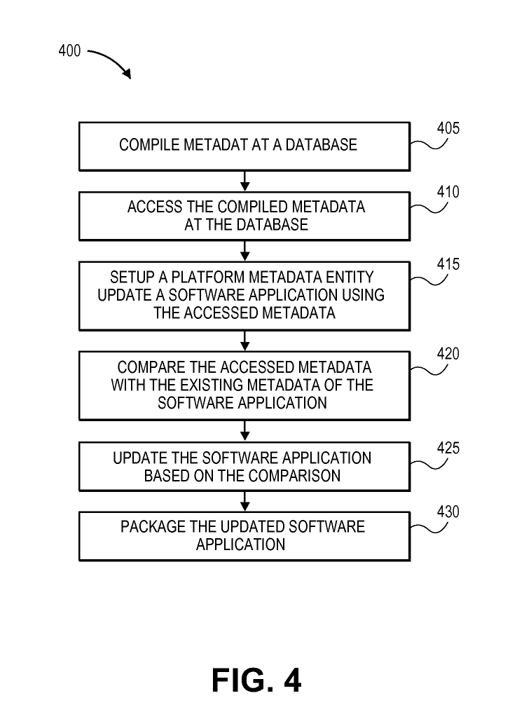

FIG. 4 illustrates a method for facilitating management of metadata for updating software applications in an on-demand services environment according to one embodiment. Method 400 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 400 is performed by the metadata management mechanism 110 of FIG. 1.

Method 400 begins at block 405 with compiling of metadata, including new and updated metadata, associated with any number of software applications received from any number of client computing devices. For example, new metadata, amended metadata, and/or information regarding deleted metadata, etc., associated with a software application may be received as provided by a number of users using their respective computing devices. The compiled metadata is then accessed, at block 410, and used to populate a platform metadata setup entity, at block 415, to update the software application.

At block 420, the received or compiled metadata is compared to the existing metadata of the software application and then updated accordingly, at block 425, to produce an updated version of the software application at block 425. At block 430, the revised version of the software application is packaged and provided to new and existing customers that may include the users providing the metadata that was compiled and used to update the software application. In one embodiment, packaging or packaging process or technique includes the compiled metadata being compared with the existing metadata of an existing or current version of a software application to detect any differences between the two sets of metadata. Based on any detected differences between compiled or received metadata and the existing metadata, the existing metadata of the existing or current version (e.g., version 2.0) of a software application is updated using the detected differences and accordingly, the current version of the software application having the existing metadata is then updated to a newer version (e.g., version 3.0) of the software application now having the newly updated metadata. The detected difference may include new metadata, changes to existing metadata, and/or deleted metadata as provided in the complied or received metadata.

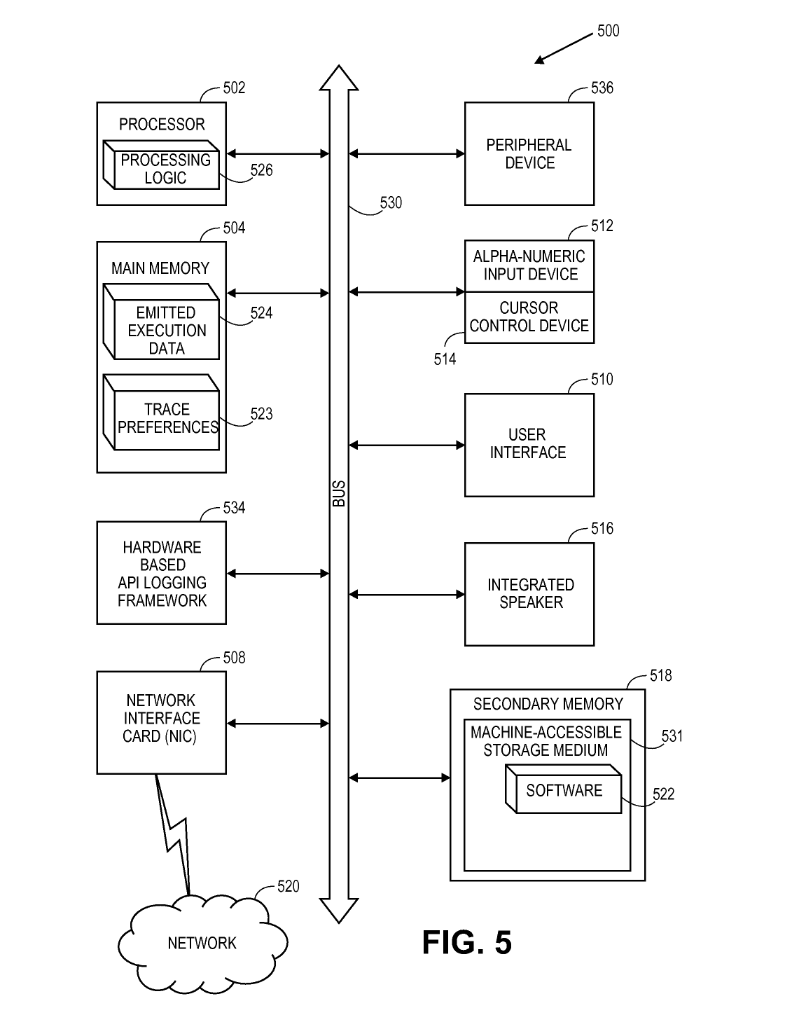

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing system 100 of FIG. 1 and computing devices 320, 330 of FIG. 3. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of metadata management mechanism 110 as described with reference to FIG. 1 and other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of metadata management mechanism 110 as described with reference to FIG. 1 and other figures described herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer -readable media, such as non-transitory computer-readable storage media (e.g., magnetic disks; optical disks; random access memory; read only memory; flash memory devices; phase-change memory) and transitory computer -readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

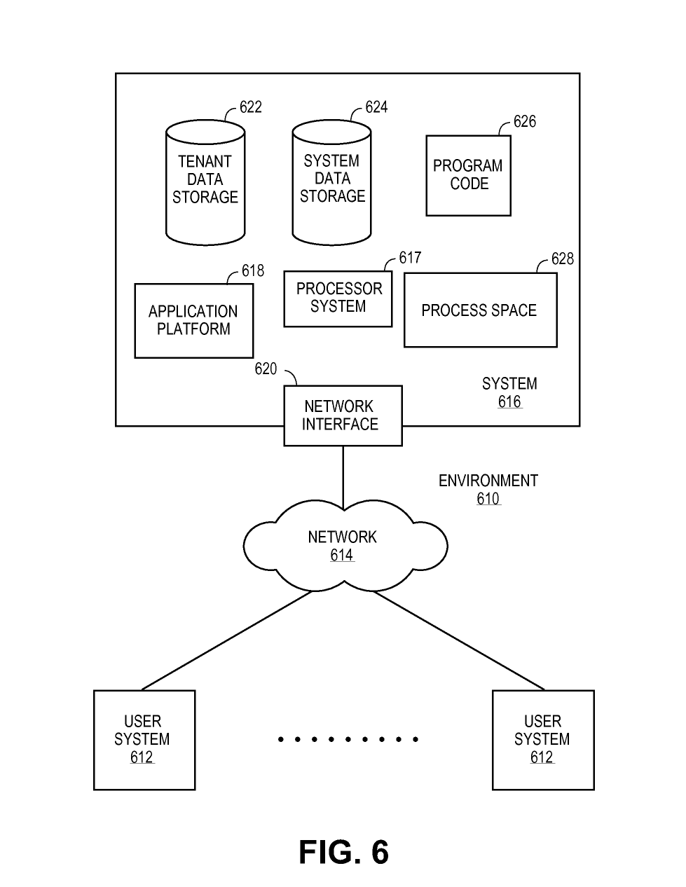

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

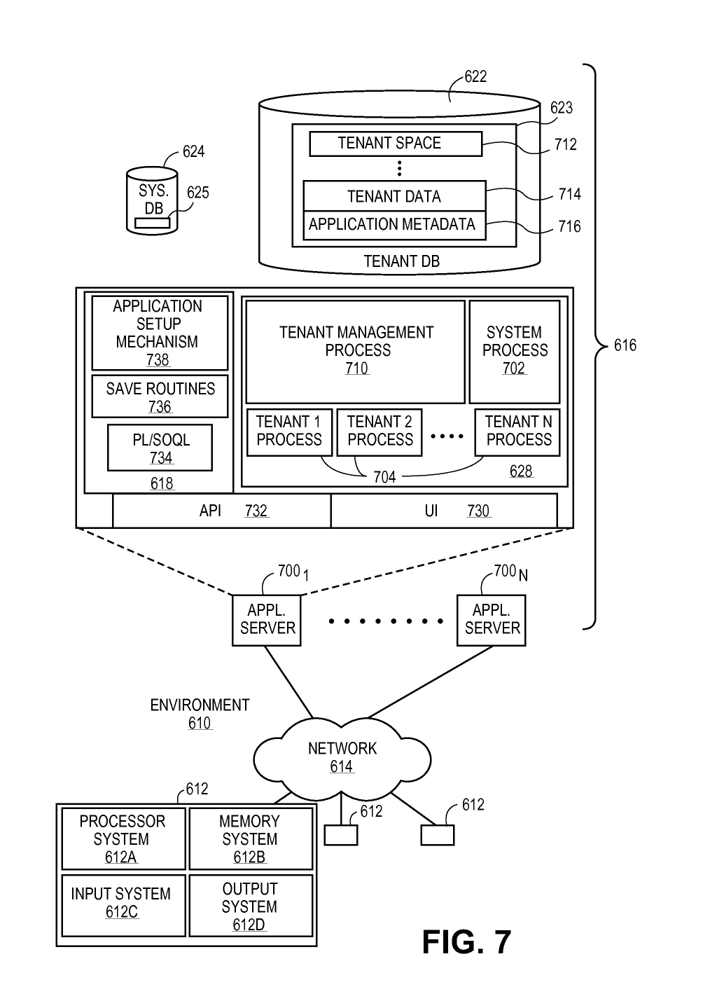

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Pentium® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N}-₁ might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users’ data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A computer-implemented method comprising:
receiving metadata relating to a software application, wherein the metadata is received from one or more users via one or more computing devices hosting the software application;
generating a platform setup entity to process the received metadata;
updating existing metadata of the software application using the received metadata; and
packaging a newer version of the software application having the updated existing metadata.

2. The computer-implemented method of claim 1, further comprising prior to updating the existing metadata, comparing the received metadata with the existing metadata of the software application, wherein an existing version the software application having the existing metadata is revised to the newer version of the software application having the updated existing metadata.

3. The computer-implemented method of claim 2, further comprising communicating the newer version of the software application to customers including the one or more users.

4. The computer-implemented method of claim 1, further comprising compiling the received metadata, and storing the compiled metadata at a database.

5. The computer-implemented method of claim 4, further comprising accessing the complied metadata at the database, wherein the accessed metadata is used to populate the platform entity.

6. The computer-implemented method of claim 1, wherein the one or more computing devices comprise one or more of mobile computing devices, personal digital assistant (PDA), a handheld computer, an e-reader, a tablet computer, a notebook, a netbook, a desktop computer, a server computer, a cluster-based computer, and a set-top box.

7. A system comprising:
a computing device having a memory to store instructions, and a processing device to execute the instructions, wherein the instructions cause the processing device to:
receive metadata relating to a software application, wherein the metadata is received from one or more users via one or more computing devices hosting the software application;
generate a platform setup entity to process the received metadata;
update existing metadata of the software application using the received metadata; and
package a newer version of the software application having the updated existing metadata.

8. The system of claim 7, wherein the processing device is further to prior to updating the existing metadata, compare the received metadata with the existing metadata of the software application, wherein an existing version the software application having the existing metadata is revised to the newer version of the software application having the updated existing metadata.

9. The system of claim 8, wherein the processing device is further to communicate the newer version of the software application to customers including the one or more users.

10. The system of claim 7, wherein the processing device is further to compile the received metadata, and storing the compiled metadata at a database.

11. The system of claim 10, wherein the processing device is further to access the complied metadata at the database, wherein the accessed metadata is used to populate the platform entity.

12. The system of claim 10, wherein the one or more computing devices comprise one or more of mobile computing devices, personal digital assistant (PDA), a handheld computer, an e-reader, a tablet computer, a notebook, a netbook, a desktop computer, a server computer, a cluster-based computer, and a set-top box.

13. A machine-readable medium having stored thereon instructions which, when executed by a machine, cause the machine to:
receiving metadata relating to a software application, wherein the metadata is received from one or more users via one or more computing devices hosting the software application;
generating a platform setup entity to process the received metadata;
updating existing metadata of the software application using the received metadata; and
packaging a newer version of the software application having the updated existing metadata.

14. The machine-readable medium of claim 13, wherein the machine is further to update the existing metadata, comparing the received metadata with the existing metadata of the software application, wherein an existing version the software application having the existing metadata is revised to the newer version of the software application having the updated existing metadata.

15. The machine-readable medium of claim 14, wherein the machine is further to communicate the newer version of the software application to customers including the one or more users.

16. The machine-readable medium of claim 13, wherein the machine is further to compile the received metadata, and storing the compiled metadata at a database.

17. The machine-readable medium of claim 16, wherein the machine is further to access the complied metadata at the database, wherein the accessed metadata is used to populate the platform entity.

18. The machine-readable medium of claim 13, wherein the one or more computing devices comprise one or more of mobile computing devices, personal digital assistant (PDA), a handheld computer, an e-reader, a tablet computer, a notebook, a netbook, a desktop computer, a server computer, a cluster-based computer, and a set-top box.
